(19) United States
(12) Patent Application Publication
(10) Pub. No.: US 2010/0259731 A1
(43) Pub. Date: Oct. 14, 2010

(54) ILLUMINATION SYSTEM, HIGH-PRESSURE DISCHARGE LAMP AND IMAGE PROJECTION SYSTEM

(75) Inventors: Yuri Aksenov, Turnhout (BE); Herman Muller, Turnhout (BE); Albert Bijlsma, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/740,384

(22) PCT Filed: Nov. 6, 2008
(86) PCT No.: PCT/IB08/54625

§ 371 Date: Apr. 29, 2010

(30) Foreign Application Priority Data
Nov. 6, 2007 (EP) 07120087.7

(51) Int. Cl. G03B 21/28; F21V 7/07

(52) U.S. Cl. 353/98; 362/296.05

(57) ABSTRACT

The invention relates to an illumination system(100), a high-pressure discharge lamp (90) and an image projection system. The illumination system comprises a high-pressure discharge lamp and a back reflector (30) reflecting the light emitted by the high-pressure discharge lamp towards a light exit window (50). The back reflector comprises an optical axis (55). The high-pressure discharge lamp comprises a discharge vessel (90) comprising two electrodes (98, 99) between which, during operation, a discharge arc is produced. The discharge vessel comprises a first part (10) arranged at least partially between the discharge arc and the back reflector, and a second part (20) arranged at least partially between the discharge arc and the light exit window. The second part has a different shape compared to the first part, thereby forming a refractive element in the second part for reducing an angular distribution at the light exit window of the light emitted from the discharge arc and refracted By the second part. The measures according to the invention have the effect that, due to the reduction of the angular distribution at the light exit window, the specific refractive property of the second part improves the efficiency of the illumination system.

### FIELD OF THE INVENTION

The invention relates to an illumination system comprising a high-pressure discharge lamp at least partially surrounded by a back reflector.

The invention also relates to a high-pressure discharge lamp for use in the illumination system, and to an image projection system comprising the illumination system.

### BACKGROUND OF THE INVENTION

Illumination systems comprising a high-intensity discharge lamp are known per se. They are used, inter alia, in image projection systems such as beamers and projection televisions. In such an image projection system, the light generated in the illumination system impinges on an image creation unit, for example, a Liquid Crystal Display (further also indicated as LCD) or, for example, a Digital Light Processing unit (further also indicated as DLP) or, for example, a Liquid Crystal on Silicon (further also indicated as LCoS), after which the image is projected onto a screen or wall. The image projection system may also be used in rapid prototyping systems (3D printers) and lithography systems. The quality of such an image projection system is often indicated by the brightness of the image which the system can produce. This brightness of the image projection system is directly related to the brightness of the illumination system.

Such an illumination system for use in a liquid crystal light valve projector is known, for example, from international patent application WO 86/00685. This document describes an illumination system which comprises a discharge lamp used in conjunction with an elliptical reflector. An axis of the elliptical reflector between the primary focus and the secondary focus is tilted at an angle to the lamp axis. Furthermore, the axis of the elliptical reflector is displaced from the lamp axis to a predetermined extent. The combination of tilting and displacement of the axis of the elliptical reflector increases the illumination uniformity and efficiency at the aperture.

The known illumination system has the disadvantage that its brightness is still insufficient.

### OBJECT AND SUMMARY OF THE INVENTION

It is an object of the invention to provide an illumination system having an improved brightness.

According to a first aspect of the invention, this object is achieved with an illumination system comprising a high-pressure discharge lamp at least partially surrounded by a back reflector which is capable of reflecting light emitted by the high-pressure discharge lamp towards a light exit window of the illumination system,

the back reflector comprising an optical axis,

the high-pressure discharge lamp comprising a discharge vessel enclosing a discharge space and comprising two electrodes between which, during operation, a discharge arc is produced, the discharge arc being located substantially at a focal point of the back reflector on the optical axis,

the discharge vessel comprising a first part arranged at least partially between the discharge arc and the back reflector, and a second part arranged at least partially between the discharge arc and the light exit window, the second part having a different shape compared to the first part, thereby forming a refractive element in the second part for reducing an angular distribution at the light exit window of the light emitted from the discharge arc and refracted by the second part.

The measures according to the invention have the effect that the shape of the second part of the discharge vessel of the high-pressure discharge lamp forms a refractive element, or lens. Light transmitted by the second part is redirected due to the refractive character of the second part. The shape of the second part is chosen to be such that the refractive character of the second part reduces an angular distribution of the light impinging on the light exit window. In the known illumination systems, the high-pressure discharge lamp is constituted by two substantially identical parts. The two parts generally have a conical shape and are produced by using the same production molds so that they are identical within the accuracy parameters of the production process used. At the narrow end of the conical shape, an electrode protrudes through the wall of the part of the discharge vessel. The known high-pressure discharge lamp is produced by connecting the wide ends of two conically shaped parts of the discharge vessel. Light emitted by a known high-pressure discharge lamp and impinging on the back reflector at a distance from the optical axis typically propagates towards the light exit window at a relatively large angle to the normal axis of the light exit window, and will thus impinge on the light exit window at a substantially large angle. This creates a relatively large angular distribution of the light impinging on the light exit window around the normal axis of this window. Due to this relatively large angle of the impinging light, part of the light may not be able to propagate through the remainder of the optical system which typically accepts only a limited range of angles of incidence. This will reduce the efficiency of the known illumination system. In the illumination system according to the invention, the first and the second part have a different shape. The shape of the second part is chosen to form a refractive element redirecting the light emitted by the discharge arc towards the back reflector so that the redirected light impinges on the back reflector at an angle closer to a normal axis of this reflector. The subsequently reflected light will propagate towards the light exit window and impinges on the light exit window at an angle closer to the normal axis of this window, thus reducing the angular distribution of the light impinging on the light exit window. Due to the reduction of the angular distribution of the impinging light on the light exit window, less of the reflected light may be lost, which enhances the brightness of the illumination system according to the invention.

The optimum shape of the second part may be determined, for example, by using optical modeling software, such as ASAP®, lighttools®, etc.

In an embodiment of the illumination system, the first part of the discharge vessel forms a further refractive element for reducing a size of an image of the discharge arc, the image being produced by light refracted by the first part and reflected from the back reflector. The high-pressure discharge lamp emits the light from the discharge arc. The discharge arc is not a point source but has a specific dimension. Possibly together with further optical elements, the back reflector generates an image of the discharge arc. In the known illumination systems, the image produced by light emitted from the discharge arc via the first part of the discharge vessel may be relatively large and may be larger than a diaphragm of an optical system which uses the light of the illumination system. Due to this relatively large image, part of the light transmitted by the first part may be lost, thereby reducing the efficiency and brightness of the known illumination system. In the illumination system according to the invention, the shape of the first part of the discharge vessel is adapted to generate a further refractive element. The shape of this further refractive element at the first part is chosen to be such that the size of the image of the discharge arc is reduced. The efficiency of the illumination system is increased by the reduction of magnification of the image produced by light refracted by the first part. The first part of the discharge vessel may have such a shape that substantially all light refracted by the first part and reflected from the back reflector is transmitted through the diaphragm of the optical system, thus substantially avoiding loss of light.

Again, the optimal shape of the first part of the discharge vessel may be determined by using optical modeling software, such as ASAP®, lighttools®, etc.

The inventors have found that the efficiency of the known illumination system is mainly limited by two different effects. A first effect is the relatively large angular distribution at the light exit window, which is mainly caused by light transmitted by the second part of the discharge vessel. A second effect is the relatively large magnification of the image of the discharge arc at the light exit window, which may cause loss of light. This second effect is mainly caused by the light which is transmitted by the first part of the discharge vessel. By choosing a specific shape of both the first and the second part of the discharge vessel in the high-pressure discharge lamp of the illumination system according to the invention, both the angular distribution at the light exit window and the magnification of the image of the discharge arc are reduced. As a result, the efficiency of the illumination system according to the invention is increased.

In an embodiment of the illumination system, the back reflector is an ellipsoidal back reflector having the focal point and a further focal point, wherein the ellipsoidal back reflector comprises spherical aberrations for redirecting the light transmitted by the second part and/or the first part towards the further focal point. The ellipsoidal back reflector generally has two focal points. Generally, the light source is located at one of the focal points, and the diaphragm of the remainder of the optical system is located at the further focal point. Due to the fact that the second part and/or the first part are refractive elements, the use of the ellipsoidal back reflector may not reflect all light emitted by the high-pressure discharge lamp from the focal point towards the diaphragm located at the further focal point. Due to the refractive properties of the discharge vessel, a substantially perfect ellipsoidal back reflector is thus no longer optimal. By adding spherical aberrations to the ellipsoidal back reflector, it may be adapted to substantially reflect all light emitted via the first and the second part towards the further focal point. The choice of the added spherical aberrations may be such that, in combination with the refractive properties of the first and/or the second part of the discharge vessel, substantially all light emitted by the discharge arc is transmitted by the diaphragm located at the further focal point.

In an embodiment of the illumination system, the spherical aberrations comprise first-order aberrations and/or second-order aberrations and/or third-order aberrations. The spherical aberrations required to further improve the efficiency of the illumination system according to the invention may be any combination of first-order, second-order and third-order aberrations. The spherical aberrations which may be chosen to obtain an optimal shape of the back reflector of the illumination system may be determined by using optical modeling software, such as ASAP®, lighttools®, etc.

In an embodiment of the illumination system, the discharge vessel comprises a wall having an outer surface and an inner surface, a shape of the outer surface of the second part being substantially identical to the shape of the outer surface of the first part, and a shape of the inner surface of the second part being different from the shape of the inner surface of the first part, thereby forming the refractive element in the second part. This embodiment has the advantage that it is relatively easy to produce. Generally, the discharge vessel is constituted by two halves each having substantially cylindrical inner walls. By pushing the two halves together at a high temperature so as to obtain the discharge vessel, the inner wall is pushed out to form an inner curved wall. By simply altering the pressure at which the two halves are pressed together during the production process, the curvature of the inner wall may thus be adapted and controlled.

In an embodiment of the illumination system, an inner diameter of the second part at a distance from the focal point is at least 10% larger than an inner diameter of the first part at the same distance from the focal point on an opposite side of the focal point, the inner diameter of the first and the second part being defined in a direction substantially perpendicular to the optical axis.

In an embodiment of the illumination system, the inner diameter of the second part at a range of distances from the focal point is at least 10% larger than the inner diameter of the first part at matching distances in a matching range of distances from the focal point on the opposite side of the focal point. An asymmetry of at least 10% results in a measurable improvement of the efficiency and typically exceeds the production process window of contemporary production processes.

In an embodiment of the illumination system, the inner wall of the first part and/or the inner wall of the second part of the discharge vessel in a cross-sectional view along a plane comprising the optical axis is convexly shaped towards the discharge arc, or is concavely shaped towards the discharge arc, or is linearly shaped. When the first part and/or the second part are convexly shaped, the wall of the discharge vessel is relatively far remote from the discharge arc, resulting in a relatively low temperature of the wall of the discharge vessel and thus limiting the strain in the discharge vessel material between a situation in which the high-pressure discharge lamp is switched on and a situation in which the high-pressure discharge lamp is switched off. A substantially linear shape of the first part and/or the second part has the advantage that the asymmetric discharge vessel can be manufactured relatively easily because the initial shape of a quartz tube before shaping is a substantially hollow cylinder shape with straight inner walls. During manufacture of the discharge vessel, the inner wall of the discharge vessel may not become hot enough to produce a convex or concave shape.

The invention also relates to a high-pressure discharge lamp as defined in claim 9 and to an image projection system as defined in claim 10.

### BRIEF DESCRIPTION OF THE DRAWINGS

These and other aspects of the invention are apparent from and will be elucidated with reference to the embodiments described hereinafter.

In the drawings:

FIG. 1 is a schematic representation of an illumination system according to the invention,

FIGS. 2A, 2B, 2C and 2D show different embodiments of high-pressure discharge lamps having asymmetric discharge vessels according to the invention,

FIG. 3A shows several light rays originating from the discharge arc in a known illumination system, and FIG. 3B shows several light rays originating from the discharge arc in the illumination system according to the invention,

FIG. 4 shows an image projection system comprising the illumination system according to the invention.

The Figures are purely diagrammatic and not drawn to scale. Particularly for clarity, some dimensions are strongly exaggerated. Similar components in the Figures are denoted by the same reference numerals as much as possible.

### DESCRIPTION OF EMBODIMENTS

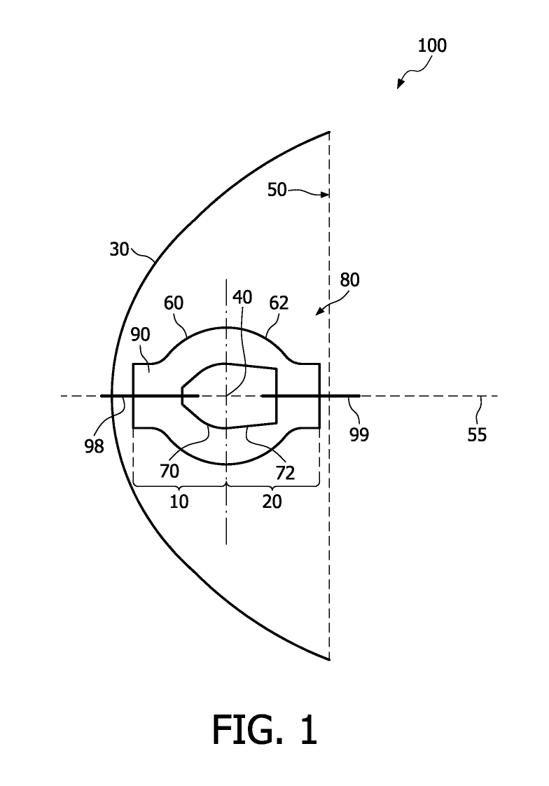

FIG. 1 is a schematic representation of an illumination system 100 according to the invention. The illumination system 100 comprises a high-pressure discharge lamp 80 and a back reflector 30 which reflects part of the light emitted by the high-pressure discharge lamp 80 towards a light exit window 50. The high-pressure discharge lamp 80 comprises a discharge vessel 90 having two electrodes 98, 99 between which, during operation, a discharge arc is produced. The high-pressure discharge lamp 80 is also known as a short-arc high-pressure discharge lamp with a typical electrode distance in a range from 1 to 3 millimeters. In the embodiment shown in FIG. 1, the electrodes 98, 99 are arranged parallel to an optical axis 55. Alternatively, the electrodes may be arranged substantially perpendicularly (not shown) to the optical axis 55. The discharge vessel 90 as shown in FIG. 1 is constituted by a first part 10 arranged at least partially between the discharge arc and the back reflector 30, and a second part 20 arranged at least partially between the discharge arc and the light exit window 50. The second part 20 has a different shape compared to the first part 10, causing the discharge vessel 90 to be shaped asymmetrically.

The shape of the second part 20 is chosen to be such that the second part 20 of the discharge vessel 90 forms a refractive element which refracts light transmitted by the second part 20 and reflected towards the light exit window 50 via the back reflector 30 so that an angular distribution of the light impinging on the light exit window 50 is reduced. Due to the refractive character of the second part 20, light which is emitted via the second part 20 impinges on the back reflector 30 at an angle closer to a normal axis (not shown) of the back reflector 30. The subsequently reflected light will propagate towards the light exit window 50 and impinges on this window 50 at an angle closer to its normal (not shown), thus reducing the angular distribution of the light impinging on the light exit window 50. By reducing the angular distribution of the light impinging on the light exit window 50, more light will travel through the optical system (not shown) which may be present at or behind the light exit window 50 and thus improves the efficiency of the illumination system 100.

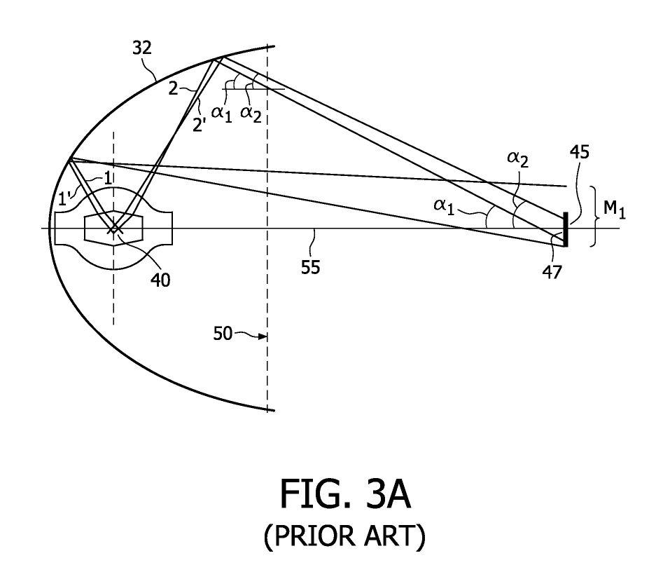

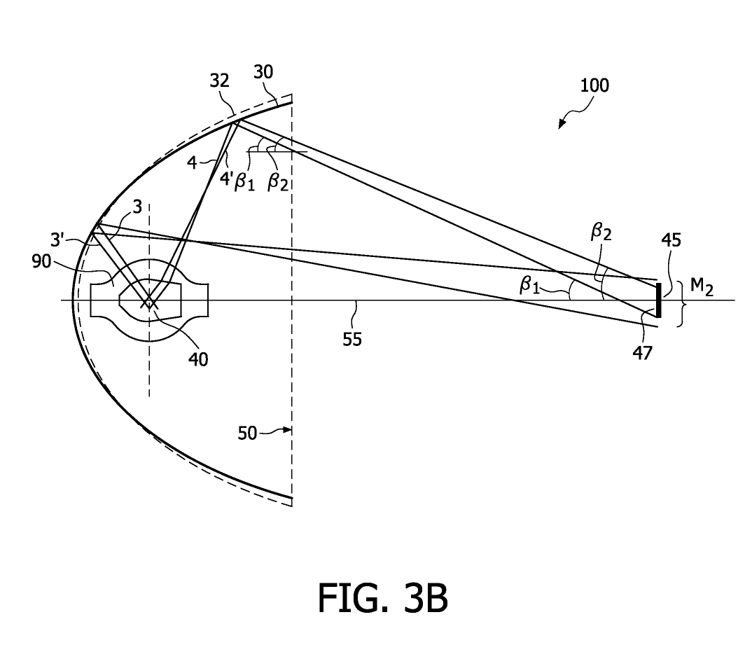

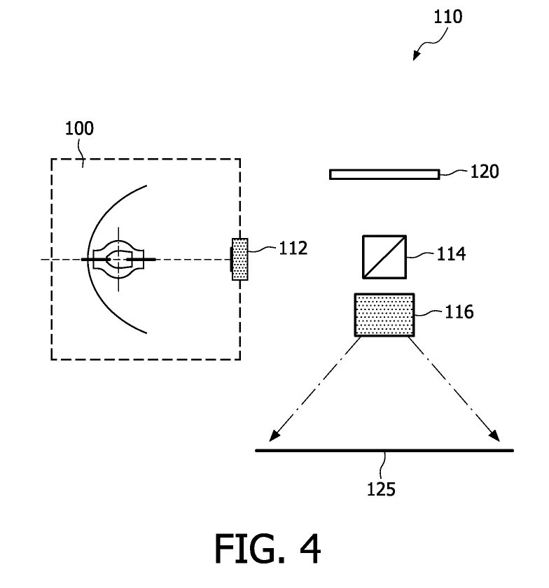

Generally, the back reflector 30 is an ellipsoidal back reflector 30 (see FIG. 3) which comprises a focal point 40 at which the discharge arc of the high-pressure discharge lamp 80 is located, and a further focal point 45 (see FIG. 3) at which, for example, a diaphragm 47 (see FIG. 3) of a further optical system 112 (see FIG. 4) is located.

To further improve the efficiency of the illumination system 100, the first part 10 of the discharge vessel 90 may be shaped to form a further refractive element. This further refractive element may be shaped in such a way that a size of an image of the discharge arc is reduced. The high-pressure discharge lamp 90 emits the light from the discharge arc. The discharge arc is not a point source but has a specific dimension. Possibly together with other optical elements, the back reflector 30 generates an image of the discharge arc at the further focal point 45. This image of the discharge arc may be too large as compared to the diaphragm 47 (which is shown in FIG. 3A, light rays 1,1′). This may be, for example, the case in the known illumination systems. Due to this relatively large image, part of the light transmitted by the first part 10 may be lost, which reduces the efficiency and brightness of the known illumination system. In the illumination system 100 according to the invention, the shape of the first part 10 of the discharge vessel 90 is adapted so as to obtain a refractive element. The shape of the refractive element at the first part 10 is chosen to be such that the size of the image of the discharge arc is reduced. When the back reflector 30 is ellipsoidal, it will create the image of the discharge arc at the further focal point 45. Ideally, the image of the discharge arc at the further focal point 45 is equal to or smaller than the dimensions of the diaphragm 47. The reduction of magnification of the image produced by light refracted by the first part 10 thus further enhances the efficiency of the illumination system 100.

The inventors have found that an even further improvement of the efficiency of the illumination system 100 according to the invention is achieved when the ellipsoidal back reflector 30 comprises spherical aberrations. The spherical aberrations may be chosen to be such that light refracted by the second part 20 and/or refracted by the first part 10 may be redirected towards the further focal point 45. When the high-pressure discharge lamp 90 is considered to be a point light source, a perfect ellipsoidal back reflector will reflect substantially all light emitted by the point light source (typically located at the focal point 40 of the ellipsoidal back reflector) to its further focal point 45. However, due to the asymmetrical shape of the discharge vessel 90, the first part 10 and the second part 20 behave as lens elements redirecting the light which is transmitted by the first part 10 and the second part 20. As a result, the perfect ellipsoidal back reflector is not ideal for reflecting substantially all light emitted via the first part 10 and/or the second part 20 towards the further focal point 45. The inventors have found that addition of spherical aberrations to the ellipsoidal back reflector 30 may further enhance the efficiency of the illumination system 100 according to the invention.

When applying the specifically shaped second part 20, the specifically shaped first part 10 and the spherical aberrations of the back reflector 30, the efficiency of the illumination system 100 according to the invention may increase by more than 10%.

The optimal shape of the first part 10 and of the second part 20 of the discharge vessel 90 may be determined by using optical modeling software. Also the spherical aberrations which provide the optimum efficiency may be determined by means of this optical modeling software. Some experimenting may be required to find the best combination for each specific purpose.

Generally, the known high-pressure discharge lamps are constituted by two substantially identical conically shaped halves. The known high-pressure discharge lamp is produced by connecting the wide ends of two conically shaped halves of the discharge vessel. The second part 20 may be obtained, for example, by reshaping one of the two halves so that the angular distribution at the light exit window 50 is reduced. The first part 10 may be obtained, for example, by reshaping the other of the two halves so that a size of an image of the discharge arc is reduced. Connecting the first part 10 and the second part 20 yields the discharge vessel 90 of the high-pressure discharge lamp 80 according to the invention. This is illustrated in FIG. 1, in which the dash-dotted line intersecting the focal point 40 indicates where the first part 10 and the second part 20 are connected to form the discharge vessel 90. Alternatively to the arrangement shown in FIG. 1, in which the two electrodes 98, 99 are arranged substantially parallel to the optical axis 55, the high-pressure discharge lamp 80 may be arranged 90° rotated, so that the two electrodes 98, 99 are arranged substantially perpendicularly to the optical axis. In such an embodiment (not shown), the second part 20 may be obtained, for example, by reshaping a part of each of the two halves which is located at least partially between the discharge arc and the light exit window 50. The first part 10 may be obtained, for example, by reshaping a further part of each of the two halves which is located at least partially between the discharge arc and the back reflector 30.

In the embodiment shown in FIG. 1, only the inner surface 72 of the wall of the second part 20 is shaped differently as compared to the inner surface 70 of the wall of the first part 10. Alternatively, the outer surface 62 of the second part 20 may be shaped differently (not shown) as compared to the outer surface 60 of the first part 10. Again alternatively, both the inner surface 72 and the outer surface 62 of the second part 20 may be shaped differently (not shown) as compared to the inner surface 70 and the outer surface 60, respectively, of the first part 10.

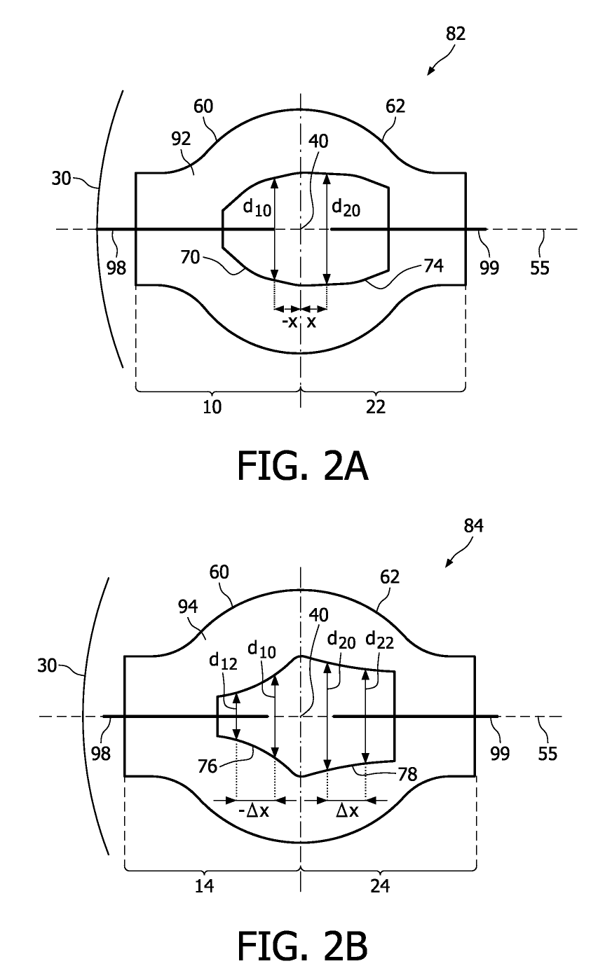

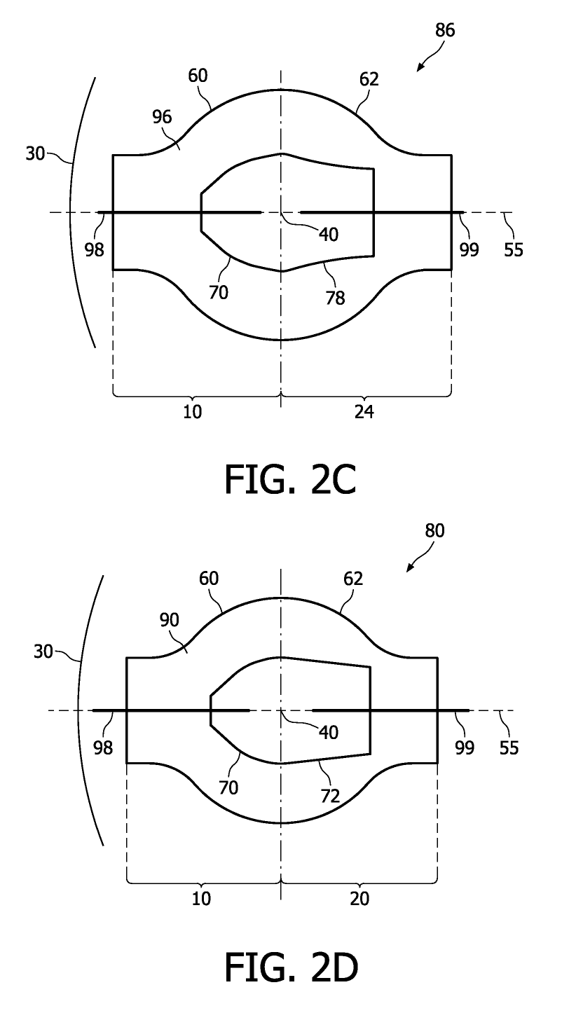

FIGS. 2A, 2B, 2C and 2D show different embodiments of high-pressure discharge lamps 80, 82, 84, 86 having asymmetric discharge vessels 90, 92, 94, 96 according to the invention. The different embodiments in FIGS. 2A, 2B, 2C and 2D are shown in a cross-sectional view along a plane comprising the optical axis 55. All of the FIGS. 2A, 2B, 2C and 2D show part of the back reflector 30, the two electrodes 98, 99 and the optical axis 55. In each FIG. 2A, 2B, 2C and 2D, the outer surface 60 of the first part 10, 14 is shaped substantially identically as compared to the outer surface 62 of the second part 20, 22, 24.

FIG. 2A is a cross-sectional view of an embodiment of the high-pressure discharge lamp 82 in which both the inner surface 70 of the first part 10 and the inner surface 74 of the second part 22 are convexly shaped towards the discharge arc. The convex shape of the inner surface 70 of the first part 10 reduces a size of the image of the discharge arc which is produced by the light transmitted by the first part 10. The convex shape of the inner surface 74 of the second part 22 reduces the angular distribution at the light exit window 50.

As is shown in FIG. 2A, a diameter d₂₀ of the second part 22 at a distance x from the focal point 40 of the back reflector is at least 10% larger than a diameter d₁₀ of the first part 10 at the same distance −x from the focal point 40 on an opposite side of the focal point 40 along the optical axis 55. The diameter of the discharge vessel 92 is measured in a direction substantially perpendicular to the optical axis 55 and is measured as an inner diameter of the discharge vessel 92. The shape of the inner surface 70, 74 of the discharge vessel 92 resembles that of a bullet.

FIG. 2B is a cross-sectional view of an embodiment of the high-pressure discharge lamp 84, in which both the inner surface 76 of the first part 14 and the inner surface 78 of the second part 24 are concavely shaped towards the discharge arc. Due to the increase of the diameter d₂₀, d₂₂ at the second part 24 of the discharge vessel 94 as compared to the diameter d₁₀, d₁₂ at the first part 14, the angular distribution at the light exit window 50 is reduced when compared to a discharge vessel in which the second part is substantially a mirror image of the first part, mirrored in a plane indicated by a dash-dotted line intersecting the focal point 40 and arranged substantially perpendicularly to the optical axis 55. This specific combination of refractive first part 14 and refractive second part 24 provides a specific light distribution at the light exit window 50.

As is shown in FIG. 2B, a diameter d₂₀−d₂₂ of the second part 24 at a range Δx of distance from the focal point 40 is at least 10% larger than a diameter d₁₀−d₁₂ of the first part 14 at matching distances in a matching range −Δx from the focal point 40 on an opposite side of the focal point 40. Again, the diameter of the discharge vessel 94 is measured in a direction substantially perpendicular to the optical axis 55 and is measured as an inner diameter of the discharge vessel 94.

FIG. 2C is a cross-sectional view of an embodiment of the high-pressure discharge lamp 86 in which the inner surface 70 of the first part 10 is convexly shaped towards the discharge arc, and the inner surface 78 of the second part 24 is concavely shaped towards the discharge arc. The convex shape of the inner surface 70 of the first part 10 reduces a dimension of the discharge arc which is produced by the light transmitted by the first part 10. The concave shape of the inner surface 78 of the second part 24 reduces the angular distribution at the light exit window 50 and may generate a specific light distribution at this window 50.

FIG. 2D is a cross-sectional view of an embodiment of the high-pressure discharge lamp 80 in which the inner surface 70 of the first part 10 is convexly shaped towards the discharge arc, and the inner surface 72 of the second part 20 is substantially linearly shaped towards the discharge arc. The convex shape of the inner surface 70 of the first part 10 reduces a dimension of the discharge arc which is produced by the light transmitted by the first part 10. The linear shape of the inner surface 72 of the second part 20 is chosen to be such that the light transmitted by the second part 20 is refracted so as to reduce the angular distribution at the light exit window 50.

Each of the different shapes of the inner surfaces 70, 72, 74, 76, 78 of the first part 10, 14 and the second part 20, 22, 24 produces a different light distribution at the light exit window 50 and may require a different set of spherical aberrations at the ellipsoidal back reflector 30 for obtaining an illumination system 100 according to the invention with a better efficiency than the known illumination systems.

FIG. 3A shows several light rays 1, l′, 2, 2′ originating from the discharge arc in a known illumination system, and FIG. 3B shows several light rays 3, 3′, 4, 4′ originating from the discharge arc in the illumination system 100 according to the invention.

In the illumination system 100 according to the invention as shown in FIG. 3B, the back reflector 30 is an ellipsoidal back reflector 30. The optical axis 55 is arranged between the focal point 40 and the further focal point 45 of the ellipsoidal back reflector 30. The second part 20 (see FIG. 1) of the discharge vessel 90 is shaped differently as compared to the first part 10 (see FIG. 1) so that the angular distribution at the light exit window 50 is reduced. The angular distribution is determined by an angle with respect to the normal axis (parallel to the optical axis 55) of the light exit window 50 of the light impinging on this window 50. In the known illumination system as shown in FIG. 3A, the first and the second part of the discharge vessel are shaped substantially identically. The light rays 2, 2′ as shown in FIG. 3A originate from the discharge arc and are reflected by the back reflector 32 towards the further focal point 45 via the light exit window 50. The angles at which the light rays impinge on the light exit window 50 are indicated by a first angle a and a second angle α₂. As can be seen in FIG. 3A, the light rays impinge on the diaphragm 47 arranged at the further focal point 45 at the same first angle α₁ and second angle α₂. In comparison, the discharge vessel 90 shown in FIG. 3B comprises the second part 20 (see FIG. 1) which is reshaped in such a way that the angular distribution at the light exit window 50 is reduced. Also FIG. 3B shows light rays 4, 4′ which originate from the discharge arc and are reflected by the back reflector 30. Due to the reshaping of the second part 20 of the discharge vessel 90, the light emitted by the discharge arc is refracted by the second part 20 and impinges on the back reflector 30 at an angle closer to the normal on the back reflector 30. The subsequently reflected light propagates towards the light exit window 50 and impinges on this window 50 at reduced angles β₁, β₂ as compared to the known illumination system shown in FIG. 3A. This is shown in FIG. 3B, in which β₁<α₁ and β₂<α₂. As can be seen in FIG. 3B, the light rays also impinge on the diaphragm 47 at reduced angles β₁, β₂. Due to this reduction of the angular distribution at the light exit window 50 (and at the diaphragm 47), the efficiency of the illumination system 100 according to the invention is improved as compared to the known illumination system.

Furthermore, FIG. 3A shows a magnification M₁ of an image of the discharge arc in the known illumination system, which is produced by using light transmitted through a part of the discharge vessel arranged between the discharge arc and the back reflector 32. When this magnification is larger than the diaphragm 47 at the further focal point 45, light is lost in the known illumination system. In the illumination system 100 according to the invention as shown in FIG. 3B, the first part 10 (see FIG. 1) of the discharge vessel 90 is reshaped to reduce a magnification M₂ of the discharge arc for the light transmitted by the first part 10 of the discharge vessel 90 and reflected from the back reflector 30. In FIG. 3B, this reduced magnification is indicated by the magnification M₂. The magnification M₂ is preferably chosen to be such that substantially the whole image of the discharge arc produced by refraction via the first part 10 and reflection from the back reflector 30 is smaller or equal in size as compared to the diaphragm 47.

FIG. 3B shows a back reflector 30 which comprises spherical aberrations so that light which is refracted by the first part 10 and/or the second part 20 is reflected back to the further focal point 45. In the known illumination systems, the back reflector 32 generally has a substantially perfect ellipse shape. When the discharge arc is located at the focal point 40 of the back reflector 32 and the diaphragm 47 is located at the further focal point 45 of the back reflector 32, substantially all light emitted by the discharge arc impinges on the diaphragm 47. However, due to the reshaping of the first part 10 and/or the second part 20 in the discharge vessel 90 according to the invention, the substantially perfect ellipse shape of the known back reflector 32 (indicated by a broken line in FIG. 3B) does not reflect substantially all light emitted by the discharge arc towards the further focal point 45. To correct the refractive characteristics of the first part 10 and/or second part 20, the ellipsoidal back reflector 30 comprises spherical aberrations.

FIG. 4 shows an image projection system 110 comprising the illumination system 100 according to the invention. The image projection system 110 comprises a shaping lens 112 for shaping the light emitted by the illumination system 100 so as to illuminate a digital light processor 120 via a beam-splitter 114. The modulated reflected light from the digital light processor 120 is imaged onto a screen 125 via a projection lens 116. Alternatively, the image projection system may use, for example, a liquid crystal display module (not shown), which is used as a light valve in transmission.

The image projection system 110 may be, for example, a beamer or a projection television. Alternatively, the image projection system 110 may be a rapid prototyping system (3D printers) or a lithography system.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements. In the device claim enumerating several means, several of these means may be embodied by one and the same item of hardware. The mere fact that certain measures are recited in mutually different dependent claims does not indicate that a combination of these measures cannot be used to advantage.

1. An illumination system comprising a high-pressure discharge lamp at least partially surrounded by a back reflector for reflecting light emitted by the high-pressure discharge lamp towards a light exit window of the illumination system,
the back reflector having an optical axis,
the high-pressure discharge lamp comprising a discharge vessel enclosing a discharge space and comprising two electrodes between which, during operation, a discharge arc is produced, the discharge arc being located substantially at a focal point of the back reflector on the optical axis, and
the discharge vessel comprising a first part arranged at least partially between the discharge arc and the back reflector, and a second part arranged at least partially between the discharge arc and the light exit window, the second part having a different shape compared to the first part, thereby forming a refractive element in the second part for reducing an angular distribution at the light exit window of the light emitted from the discharge arc and refracted by the second part, wherein the back reflector is an ellipsoidal back reflector having the focal point and a further focal point, wherein the ellipsoidal back reflector comprises spherical aberrations for redirecting the light transmitted by the second part and/or the first part towards the further focal point.

2. An illumination system as claimed in claim 1, wherein the first part of the discharge vessel forms a further refractive element for reducing a size of an image of the discharge arc, the image being produced by light refracted by the first part and reflected from the back reflector.

3. (canceled)

4. An illumination system as claimed in claim 1, wherein the spherical aberrations comprise first-order aberrations and/or second-order aberrations and/or third-order aberrations.

5. An illumination system as claimed in claim 1, wherein the discharge vessel comprises a wall having an outer surface and an inner surface, a shape of the outer surface of the second part being substantially identical to the shape of the outer surface of the first part, and a shape of the inner surface of the second part being different from the shape of the inner surface of the first part, thereby forming the refractive element in the second part.

6. An illumination system as claimed in claim 5, wherein an inner diameter (d₂₀) of the second part at a distance (x) from the focal point is at least 10% larger than an inner diameter (d₁₀) of the first part at the same distance (−x) from the focal point on an opposite side of the focal point, the inner diameter (d₁₀, d₂₀) of the first part and the second part being defined in a direction substantially perpendicular to the optical axis.

7. An illumination system as claimed in claim 6, wherein the inner diameter (d₂₀−d₂₂) of the second part at a range (Δx) of distances from the focal point is at least 10% larger than the inner diameter (d₁₀−d₁₂) of the first part at matching distances in a matching range (−Δx) of distances from the focal point on the opposite side of the focal point.

8. An illumination system as claimed in claim 1, wherein the inner wall of the first part and/or the inner wall of the second part of the discharge vessel in a cross-sectional view along a plane comprising the optical axis is convexly shaped towards the discharge arc, or is concavely shaped towards the discharge arc, or is linearly shaped.

9. (canceled)

10. An image projection system (110) comprising the illumination system as claimed in claim 1.
